(19) United States
(12) Patent Application Publication
(10) Pub. No.: US 2014/0070910 A1
(43) Pub. Date: Mar. 13, 2014

(54) ELECTROMAGNETIC SWITCHING DEVICE

(71) Applicant: LSIS CO., LTD., Anyang-si (KR)

(72) Inventor: Jun Hyuk YANG, Daegu (KR)

(73) Assignee: LSIS CO., LTD., Anyang-si (KR)

(21) Appl. No.: 14/017,160

(22) Filed: Sep. 3, 2013

(30) Foreign Application Priority Data
Sep. 10, 2012 (KR) 10-2012-0100154

(51) Int. Cl. H01H 36/00

(52) U.S. Cl. CPC H01H 36/00
USPC 335/202

(57) ABSTRACT

Disclosed is an electromagnetic switching device. The electromagnetic switching device includes a coil assembly provided therein with a coil for generating a magnetic force; and a yoke which surrounds a portion of an outer surface of the coil assembly and into which the coil assembly is inserted, wherein the yoke includes a yoke upper part which forms a top surface; yoke side parts which are provided at one side of the yoke upper part to block the magnetic force generated from the coil; and a connection part which is disposed between the yoke upper part and the yoke side parts such that the yoke upper part and the yoke side parts are integrally formed with each other.

### CROSS-REFERENCE TO RELATED APPLICATIONS

Pursuant to 35 U.S.C. §119(a), this application claims the benefit of earlier date and right of priority to Korean Patent Application No. 10-2012-0100154, filed on Sep. 10, 2012, the contents of which is incorporated by reference herein in its entirety.

### BACKGROUND

The embodiment relates to an electromagnetic switching device.

An electromagnetic switching device is a kind of an electrical contact switching device for supplying or shutting off current, and may be used for various industrial equipments, machines or vehicles.

Hereinafter, an electromagnetic switching device according to the related art will be described.

The electromagnetic switching device according to the related art includes a coil assembly generating electromagnetic force, a shaft movably inserted into the coil assembly, and a yoke which receives the shaft and forms a frame.

The electromagnetic switching device further includes a plate provided at an upper side of the shaft so as to be coupled with the yoke.

Further, the plate and the yoke may be coupled to each other at several portions thereof.

Thus, when the plate and the yoke are coupled to each other, a gap may be formed due to spaces caused at a plurality of coupling portions, so that a magnetic force generated from the coil is weakened due to the gap.

### SUMMARY

The embodiment provides an electromagnetic switching device, in which a configuration of a yoke is simplified to minimize a gap.

The embodiment provides an electromagnetic switching device.

The embodiment provides an electromagnetic switching device including a coil assembly provided therein with a coil for generating a magnetic force; and a yoke which surrounds a portion of an outer surface of the coil assembly and into which the coil assembly is inserted, wherein the yoke includes: a yoke upper part which forms a top surface; yoke side parts which are provided at one side of the yoke upper part to block the magnetic force generated from the coil; and a connection part which is disposed between the yoke upper part and the yoke side parts such that the yoke upper part and the yoke side parts are integrally formed with each other.

The shaft assembly wherein the yoke side parts includes an opening which provides a space into which the coil assembly is inserted; a first yoke side part which is connected to the yoke upper part through the connection part; and a second yoke side part which is disposed at an opposite side of the first yoke side part.

The connection part connects the first yoke side part perpendicularly to the yoke upper part.

The connection part is molded to have a curved shape with a predetermined curvature.

The yoke upper part is provided at one side thereof with the connection part and at an opposite side thereof with a latch groove coupled with the second yoke side part.

A protrusion is formed at the second yoke side part such that the protrusion is coupled to the latch groove.

The opening includes a first opening which is formed in a space between one side of the first yoke side part and one side of the yoke side part; and a second opening which is formed in a space between an opposite side of the first yoke side part and an opposite side of the yoke side part, and wherein the coil assembly is inserted into the yoke by sequentially passing through the first opening and the second opening.

The coil assembly includes a cover which forms a top surface; and a reception part which is disposed below the cover to receive the coil.

A shaft insertion hole is formed at each of the coil assembly and the yoke as a movement passage through which a shaft moves upward and downward according to a magnetic force generated from the coil.

The shaft insertion hole includes a first shaft insertion hole formed at an upper portion of the yoke; and a second shaft insertion hole formed at the cover and the reception part, respectively.

A shaft movement guide part is formed on an inner surface of the second shaft insertion hole in order to guide the shaft to move upward and downward.

The diameters of the first shaft insertion hole and the second shaft insertion hole are equal to or larger than a diameter of the shaft.

According to the embodiment, the structure of the yoke constituting the electromagnetic switching device can be simplified, so that the cost and manufacturing process may be reduced, and coupling portions of the yoke can be minimized to reduce the gap, so that a coil driving force may be improved.

The details of one or more embodiments are set forth in the accompanying drawings and the description below. Other features will be apparent from the description and drawings, and from the claims.

### BRIEF DESCRIPTION OF THE DRAWINGS

FIG. 1 is a disassembled perspective view showing an electromagnetic switching device according to the embodiment;

FIG. 2 is an assembled perspective view showing an electromagnetic switching device according to the embodiment and

FIG. 3 is a sectional view showing an internal configuration of an electromagnetic switching device according to the embodiment.

### DETAILED DESCRIPTION OF THE EMBODIMENTS

Reference will now be made in detail to the embodiments of the present disclosure, examples of which are illustrated in the accompanying drawings.

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense.

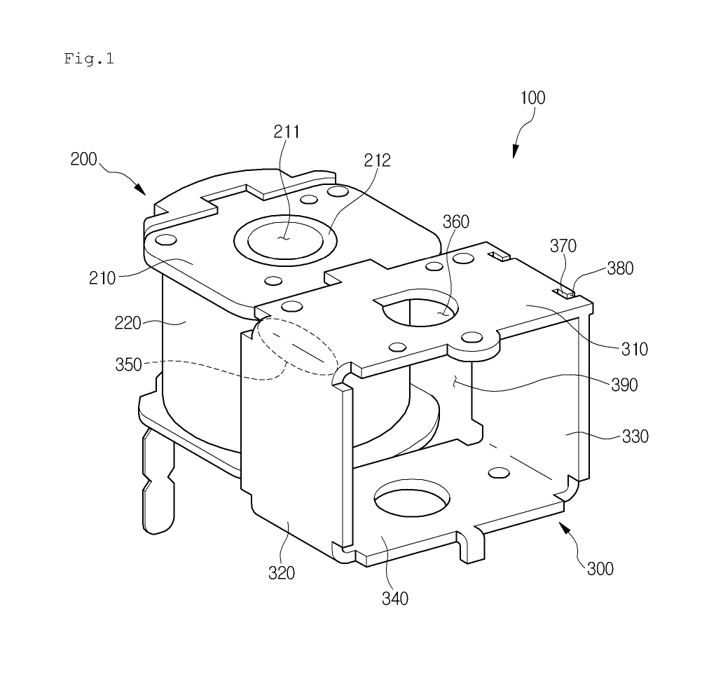

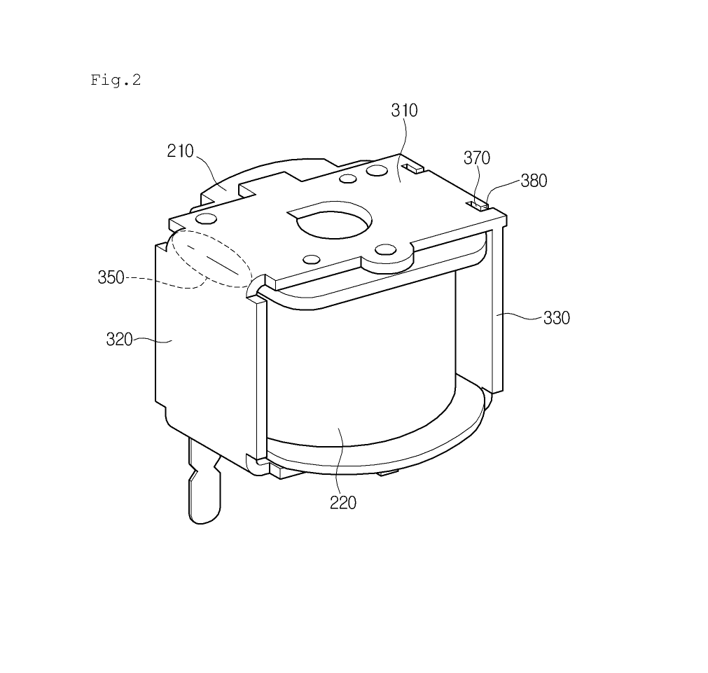

FIG. 1 is a disassembled perspective view showing an electromagnetic switching device according to the embodiment. FIG. 2 is an assembled perspective view showing the electromagnetic switching device according to the embodiment.

Referring to FIGS. 1 and 2, the electromagnetic switching device 100 may include a coil assembly 200 including a coil which generates a magnetic force therein, and a yoke 300 which surrounds a portion of the outer surface of the coil assembly 200 and in which the coil assembly 200 is inserted.

The coil assembly 200 may include a cover 210 by which a top surface of the coil assembly 200 is formed and a reception part 220 which is disposed at a lower side of the cover 210 and receives the coil.

A second shaft insertion hole 211, which is an insertion passage through which a shaft moves upward and downward according to a magnetic force of the coil, is formed at the central portions of the cover 210 and the reception part 220. A location of the second shaft insertion hole 211 is preferably formed at the central portions of the cover 210 and the reception part 220, but the embodiment is not limited thereto.

Further, the second shaft insertion hole 211 may be formed in a shape and a size corresponding to a shaft (not shown). In one embodiment, if the shaft is formed in a cylindrical shape, the second shaft insertion hole 211 may be formed in the cylindrical shape and may have a diameter equal to or slightly greater than that of the shaft.

The cover 210 may further include a shaft movement guide part 212 which guides the shaft to move upward and downward. In detail, the shaft movement guide part 212, which guides the shaft to move upward and downward, may be formed on an inner surface of the second shaft insertion hole 211.

Further, the shaft movement guide part 212 may be formed in a shape and a size corresponding to those of the second shaft insertion hole 211.

For example, if the second shaft insertion hole 211 is formed in a cylindrical shape, the shaft movement guide part 212 may be formed in the cylindrical shape and may have a diameter equal to or slightly less than that of the second shaft insertion hole 211.

The yoke 300 may include a yoke upper part 310 which forms the top surface of the yoke and guides the movement of the shaft, yoke side parts 320 and 330 connected to the yoke upper part 310 and a yoke lower part 340 connected to one sides of the first and second yoke side parts 320 and 330 and provided in opposition to the yoke upper part 310.

The yoke side parts may include the first yoke side part 320 which is connected to one side of the yoke upper part 310, the second yoke side part 330 which is connected to the other side of the yoke upper part 310 and disposed in opposition to the first yoke side part 320, and an opening 390 which provides a space into which the coil assembly 200 is inserted.

Further, the yoke 300 may further include a connection part 350 disposed between the yoke upper part 310 and the first yoke side part 320 so that the first yoke side part 320 and the yoke upper part 310 are integrated with each other.

The opening 390 may include a first opening which is formed in a space between one side of the first yoke side part 320 and one side of the second yoke side part 330, and a second opening which is formed in a space between an opposite side of the first yoke side part 320 and an opposite side of the second yoke side part 330.

Thus, the coil assembly 200 may be inserted into the yoke 300 by sequentially passing through the first and second openings.

The first and second yoke side parts 320 and 330 may prevent the magnetic force generated from the coil from leaking to an outside. That is, the first and second yoke side parts 320 and 330 may block the magnetic force generated from the coil.

A first shaft insertion hole 360, which is a through-passage through which the shaft may move upward and downward according to a magnetic force, is formed at the central portion of the yoke upper part 310. In this case, the first shaft insertion hole 360 formed in the yoke upper part 310 may correspond to the first shaft hole 360 formed in the yoke lower parts 340 in the longitudinal direction. Further, the first shaft insertion hole 360 may be formed in a shape and a size corresponding to those of the shaft (not shown).

Further, the first shaft insertion hole 360 may have a diameter equal to or larger than that of the shaft, such that the shaft may more smoothly move in the first shaft insertion hole 360.

The connection part 350 is placed at one side of the yoke upper part 310 and the yoke upper part 340 and the first yoke side part 320 are integrally connected to each other through the connection part 350. The connection part 350 may be formed in a curved shape and may have a predetermined curvature. The yoke upper part 340 and the first yoke side part 320 may be connected perpendicularly to each other through the connection part 350. That is, the connection part 350 may be perpendicularly defined by a curved surface having a predetermined curvature to integrally connect the yoke upper part 310 to the yoke side part 320 in perpendicular to each other.

The opposite side of the yoke upper part 310 may be coupled to the second yoke side part 330. That is, a latch groove 380 is formed at the opposite side of the yoke upper part 310 and a protrusion 370 is formed at one side of the second yoke side part 330. Thus, the protrusion 370 may be coupled into the latch groove 380, so that the yoke upper part 310 may be coupled to the second yoke side part 330.

The latch groove 380 and the protrusion 370 may be formed in the yoke upper part 310 and the second side part 330, respectively, in correspondence with each other. In addition, it is also possible that the protrusion 370 is formed at the opposite side of the yoke upper part 310 and the latch groove 380 is formed at one side of the second yoke side part 330.

Further, the coupling position and the coupling number of the latch groove 380 and the protrusion 370 are not limited. For example, a pair of the latch groove 380 and the protrusion 370 may be formed at positions corresponding to each other about the central line transversely extending through the yoke upper part 310.

Hereinafter, an assembling process of the electromagnetic switching device 100 will be described with reference to FIGS. 1 and 2.

First, the coil assembly 200 is inserted into the yoke 300 such that a portion of the outer surface of the coil assembly 200 can be surrounded by the yoke 300. Next, the first shaft insertion hole 360 of the yoke 300 is placed at a position corresponding to a position of the second shaft insertion hole 211. Then, the shaft (not shown) is sequentially inserted into the first and second shaft insertion holes 360 and 211. In this case, the shaft is guided by the shaft movement guide part 212 so that the shaft may be inserted into the shaft insertion holes 211 and 360.

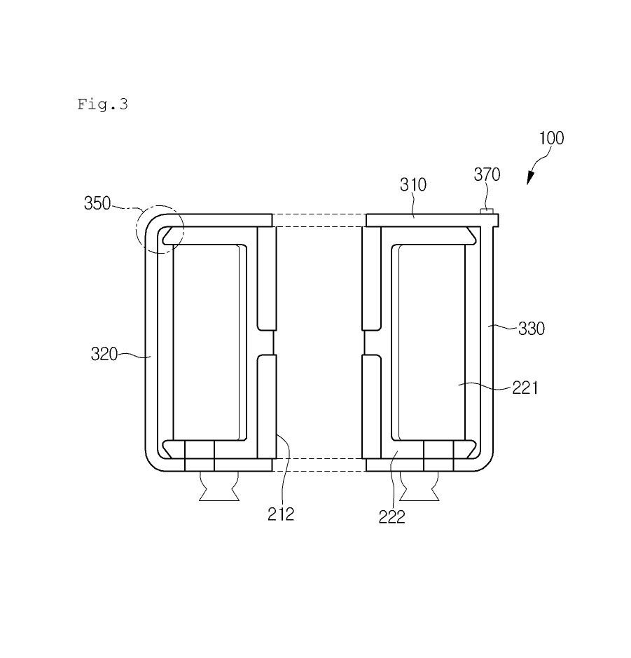

FIG. 3 is a sectional view showing an internal configuration of an electromagnetic switching device according to the embodiment.

Referring to FIG. 3, a coil assembly 200 according to the embodiment may include shaft movement guide parts 212 which guide the movement of the shaft in the upward and downward directions, frames 222 formed at both sides of the shaft movement guide parts 212 in correspondence with each other, and coils 221 received in the frames 222 to provide a magnetic force.

Hereinafter, an operation of the electromagnetic switching device 100 will be described in detail with reference to FIG. 3.

When an electric power is applied to the coil 221, a magnetic force is generated around the coil 221. Thus, a movable core (not shown) moves in an upward direction along which a magnetic resistance is reduced while the shaft (not shown) is moving upward along the shaft movement guide part 212. Since a movable contact point (not shown) is connected to one side of the shaft, the movable contact point makes contact with a fixed contact point (not shown) fixed to an upper side of the movable contact point so that an electric current passes therethrough.

Meanwhile, the electric power supplied to the coil 211 is cut off when it is necessary to cut off the current supply. As a result, the coil 221 may not generate the magnetic force and the movable core may move downward.

Thus, the shaft may move downward along the shaft movement guide part 212, and the movable contact point may be separated from the fixed contact point, so that the current may be shut off

The electromagnetic switching device according to the embodiment may further include a connection part 350 which connects the yoke upper part 310 to the first yoke side part 320 so that the yoke upper part 310, the connection part 350 and the first yoke side part 320 may be integrally connected with each other.

Therefore, different from the related art in which gaps are formed in plural portions between the plate and the yoke, according to the embodiment, the connection part 350, which integrally connects the yoke upper part 310 to the first yoke side part 320, is formed at one side of the yoke upper part 310, so that the gaps may be reduced. As a result, a driving force of the coil may be improved.

Further, the yoke upper part 310, the yoke side parts 320 and 330, and the yoke lower part 340 can be integrally formed, so that the manufacturing process may be simplified.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electromagnetic switching device comprising:
a coil assembly provided therein with a coil for generating a magnetic force; and
a yoke which surrounds a portion of an outer surface of the coil assembly and into which the coil assembly is inserted,
wherein the yoke comprises:
a yoke upper part which forms a top surface;
yoke side parts which are provided at one side of the yoke upper part to block the magnetic force generated from the coil; and
a connection part which is disposed between the yoke upper part and the yoke side parts such that the yoke upper part and the yoke side parts are integrally formed with each other.

2. The electromagnetic switching device of claim 1, wherein the shaft assembly wherein the yoke side parts comprises:
an opening which provides a space into which the coil assembly is inserted;
a first yoke side part which is connected to the yoke upper part through the connection part; and
a second yoke side part which is disposed at an opposite side of the first yoke side part.

3. The electromagnetic switching device of claim 2, wherein the connection part connects the first yoke side part perpendicularly to the yoke upper part.

4. The electromagnetic switching device of claim 2, wherein the connection part is molded to have a curved shape with a predetermined curvature.

5. The electromagnetic switching device of claim 2, wherein the yoke upper part is provided at one side thereof with the connection part and at an opposite side thereof with a latch groove coupled with the second yoke side part.

6. The electromagnetic switching device of claim 5, wherein a protrusion is formed at the second yoke side part such that the protrusion is coupled to the latch groove.

7. The electromagnetic switching device of claim 2, wherein the opening comprises:
a first opening which is formed in a space between one side of the first yoke side part and one side of the yoke side part; and
a second opening which is formed in a space between an opposite side of the first yoke side part and an opposite side of the yoke side part, and
wherein the coil assembly is inserted into the yoke by sequentially passing through the first opening and the second opening.

8. The electromagnetic switching device of claim 2, wherein the coil assembly comprises:
a cover which forms a top surface; and
a reception part which is disposed below the cover to receive the coil.

9. The electromagnetic switching device of claim 8, wherein a shaft insertion hole is formed at each of the coil assembly and the yoke as a movement passage through which a shaft moves upward and downward according to a magnetic force generated from the coil.

10. The electromagnetic switching device of claim 9, wherein the shaft insertion hole comprises:
a first shaft insertion hole formed at an upper portion of the yoke; and
a second shaft insertion hole formed at the cover and the reception part, respectively.

11. The electromagnetic switching device of claim 10, wherein a shaft movement guide part is formed on an inner surface of the second shaft insertion hole in order to guide the shaft to move upward and downward.

12. The electromagnetic switching device of claim 10, wherein diameters of the first shaft insertion hole and the second shaft insertion hole are equal to or larger than a diameter of the shaft.

13. An electromagnetic switching device comprising:
a coil assembly which includes a coil for generating a magnetic force in the coil assembly; and
a yoke which surrounds a portion of an outer surface of the coil assembly and into which the coil assembly is inserted,
wherein the yoke comprises:
a yoke upper part which forms a top surface;
a yoke side part which is provided at one side of the yoke upper part to block the magnetic force generated from the coil; and
a yoke lower part which is provided at an opposite surface of the yoke upper part and is connected to the yoke side part,
wherein the yoke upper part, the yoke side part and the yoke lower part are integrally molded.

14. The electromagnetic switching device of claim 13, wherein the yoke side part comprises:
a first yoke side part connected to one side of the yoke upper part; and
a second yoke side part formed at an opposite surface of the first yoke side part and coupled to an opposite side of the yoke upper part,
wherein the electromagnetic switching device further comprises a connection part is formed integrally with the yoke upper part and the first yoke side part to connect the yoke upper part to the first yoke side part.
